(19) United States
(12) Patent Application Publication
(10) Pub. No.: US 2025/0320091 A1
(43) Pub. Date: Oct. 16, 2025

(54) LUFFING JIB CRANE

(71) Applicant: MANITOWOC CRANE GROUP FRANCE, DARDILLY (FR)

(72) Inventors: Christophe BARBET, Trevoux (FR); Lotfi BOUSKINE, Caluire Et Cuire (FR); Gabriel FRAISSE, Anse (FR); Michael MOLLENTHIEL, Villeurbanne (FR); Mathieu BOCHER, Rillieux La Pape (FR)

(21) Appl. No.: 19/175,441

(22) Filed: Apr. 10, 2025

(30) Foreign Application Priority Data
Apr. 15, 2024 (FR) 2403878

(51) Int. Cl. B66C 23/06

(52) U.S. Cl. CPC B66C 23/06

(57) ABSTRACT

Luffing jib crane includes a mast surmounted by a rotating part orientable about a vertical axis and a rotating pivot pivotally mounted on the mast. The luffing jib crane further includes a counter-jib including a central section and a horizontal radial section directed rearwards and fastened to the central section which comprises a base fastened to the rotating pivot and a top (65) surmounting the base. The luffing jib crane further includes a luffing jib directed forwards and having a rear end articulated to the base of the central section of the counter-jib, below the top, in a manner diametrically opposed to the radial section of the counter-jib. The crane has a punch fastened to the top of the central section of the counter-jib, and extending obliquely upwards and backwards from the top.

### FIELD

The present disclosure relates to a luffing jib crane.

It relates more particularly to a crane comprising a mast surmounted by a rotating part orientable about a vertical axis and comprising a rotating pivot pivotally mounted on the mast and on which a counter-jib is fastened, which counter-jib comprising a central section and a substantially horizontal radial section directed rearwards and fastened to the central section, where the central section comprises a base fixedly mounted on the rotating pivot, and a top located above the base along the vertical axis, a luffing jib directed forwards and having a rear end articulated, about a horizontal axis, to the central section of the counter-jib, in a manner diametrically opposed to the radial section of the counter-jib, a punch fastened to the top of the central section of the counter-jib and extending obliquely upwards and backwards from this top.

### BACKGROUND

Conventionally, in a luffing jib crane, a jib lifting winch is provided which comprises a jib lifting motor which rotates, in both directions and via a reducer, a lifting drum, around which a jib lifting cable is wound which passes over one or several pulleys disposed at the top of the punch, and which also passes over the pulleys of a jib lifting block, located in front of the punch. The jib lifting block is in turn connected, by a line of tie rods, to the luffing jib.

Thus, by rotating the motor in one direction or the other, the jib lifting cable allows the luffing jib to be raised or lowered, between a low configuration in which the jib extends substantially horizontally, and a maximum raised configuration in which the jib is raised to its maximum while being inclined relative to the horizontal at an angle generally greater than 45 degrees.

Furthermore, the luffing jib cranes may comprise a mast surmounted by a rotating part orientable about a vertical axis, which orientable rotating part comprises a rotating pivot pivotally mounted on the mast.

It is known, from documents WO 2018/050278 A1 and CN 2 191 854 Y, to articulate the rear end of the jib and the front end of the counter-jib on the rotating pivot.

It is also known, as for example from SU 423 740 A1, that the rear end of the luffing jib is articulated at the same level as the foot of the punch (opposite the top of the punch), in order to position the forces of the luffing jib at the foot of the punch, in order to control the forces on this part of the structure.

To improve the performance of a luffing jib crane, it is known to lengthen the punch. Indeed, a longer punch allows to increase productivity by reducing the impact of the weight of the luffing jib on the line of tie rods (improved luffing speed), and by reducing the weight of the luffing jib by increasing the angle of the tie rod (which corresponds to the angle between the line of tie rods and the luffing jib) and thus have an improved load curve.

However, increasing the length of the punch is not without its constraints. Indeed, a longer punch takes up more space to transport, which may therefore require the use of a removable punch to remain transportable in a container or on a standard tray. In addition, a longer punch requires greater structural reinforcements on the counter-jib.

### SUMMARY

The present disclosure aims to resolve the aforementioned drawbacks by proposing a luffing jib crane architecture which makes it possible to improve performance without having to increase the length of the punch.

To this end, the present disclosure proposes a luffing jib crane comprising a mast surmounted by a rotating part orientable about a vertical axis and comprising:
a rotating pivot pivotally mounted on the mast;
a counter-jib comprising a central section and a substantially horizontal radial section directed rearwards and fastened to the central section, which central section comprising a base fixedly mounted on the rotating pivot and a top surmounting the base and located above the base along the vertical axis;
a luffing jib directed forwards and having a rear end articulated, about a horizontal axis, to the central section of the counter-jib, in a manner diametrically opposed to the radial section of the counter-jib;
a punch having a foot fastened to the top of the central section of the counter-jib, which punch supporting at least one pulley and extending obliquely upwards and rearwards from the top of the central section of the counter-jib, and where the radial section of the counter-jib is suspended from the punch by means of at least one connecting tie rod;
said luffing jib crane being remarkable in that the rear end of the luffing jib is articulated to the base of the central section of the counter-jib, below the top along the vertical axis, and therefore below the foot of the punch.

Thus, the present disclosure proposes to transfer the articulation of the luffing jib as low as possible on the central section of the counter-jib, namely at its base rather than at its top to which the foot of the punch is fastened. Thus, the length of the punch is fictitiously increased by the distance between the base and the top of the central section, in other words by the distance between the base and the foot of the punch.

Thanks to this downwards shift of the articulation of the luffing jib, the crane is greatly optimized with gains in terms of access, maintenance, force in the luffing cable and therefore productivity through a faster flight speed, reduction of force in the luffing jib and therefore reduction of weight, reduction of force in the punch (compared to an equivalent punch) and therefore weight.

According to one characteristic, the central section of the counter-jib comprises:
a front structure extending obliquely upwards and backwards and comprising an upper end at the top of the central section and a lower end at the base of the central section; and
a rear structure extending obliquely upwards and forwards and comprising an upper end at the top of the central section and a lower end at the base of the central section;
wherein the upper end of the front structure and the upper end of the rear structure are joined and secured to the top of the central section;
and wherein the punch is fastened to the upper ends of the front structure and of the rear structure and the rear end of the luffing jib is articulated to the lower end of the front structure.

According to one possibility, the punch extends in a punch direction that is inclined rearwards with respect to the vertical axis at a punch angle comprised between 10 and 50 degrees, and the front structure of the central section of the counter-jib extends in a front direction that is inclined rearwards with respect to the vertical axis at a front angle comprised between 5 and 40 degrees.

Advantageously, the punch angle and the front angle are comprised between 0 and 20 degrees; so that the punch and the front structure of the central section of the counter-jib are substantially aligned, thereby improving the fictitious increase in the length of the punch.

According to another possibility, the radial section of the counter-jib is fastened to the rear structure of the central section of the counter-jib.

According to another possibility, the radial section of the counter-jib is fastened to the upper end and the lower end of the rear structure of the central section of the counter-jib.

In a particular embodiment, the front structure of the central section of the counter-jib comprises a right front arm and a left front arm extending parallel and obliquely upwards and rearwards, the right front arm and the left front arm having respective lower terminations forming the lower end of the front structure, and respective upper terminations forming the upper end of the front structure;
and wherein the rear end of the luffing jib is articulated to the lower terminations of the right front arm and of the left front arm.

In a particular embodiment, the rear structure of the central section of the counter-jib comprises a right rear arm and a left rear arm extending parallel and obliquely upwards and forwards, the right rear arm and the left rear arm having respective lower terminations forming the lower end of the rear structure, and respective upper terminations forming the upper end of the rear structure;
wherein the upper termination of the right front arm is joined to the upper termination of the right rear arm, and the upper termination of the left front arm is joined to the upper termination of the left rear arm;
and wherein the punch is fastened to the upper terminations of the right front arm, the right rear arm, the left front arm and the left rear arm.

According to one possibility, the punch comprises a right oblique element and a left oblique element extending parallel and obliquely upwards and backwards, and wherein the right oblique element is fastened to the upper terminations of the right front arm and of the right rear arm, and the left oblique element is fastened to the upper terminations of the left front arm and of the left rear arm.

### BRIEF DESCRIPTION OF THE DRAWINGS

Other characteristics and advantages of the present disclosure will appear on reading the detailed description below, of a non-limiting example of implementation, made with reference to the appended figures in which:

FIG. 1 is a schematic side and partial view of the rotating part of a luffing jib crane according to the present disclosure, with the luffing jib in the raised configuration;

FIG. 2 is a schematic side and partial view of the rotating portion of the luffing jib crane of FIG. 1, with the luffing jib in the lowered configuration;

FIG. 3 is a schematic perspective and partial view of the rotating part of the luffing jib crane of FIG. 1, with the luffing jib in the raised configuration;

FIG. 4 is a schematic perspective and zoomed view of the area IV of FIG. 3;

FIG. 5 is a graph illustrating the variation of a force on the line of tie rods as a function of the span on the jib, in a conventional luffing jib crane and in a luffing jib crane according to the present disclosure.

### DESCRIPTION

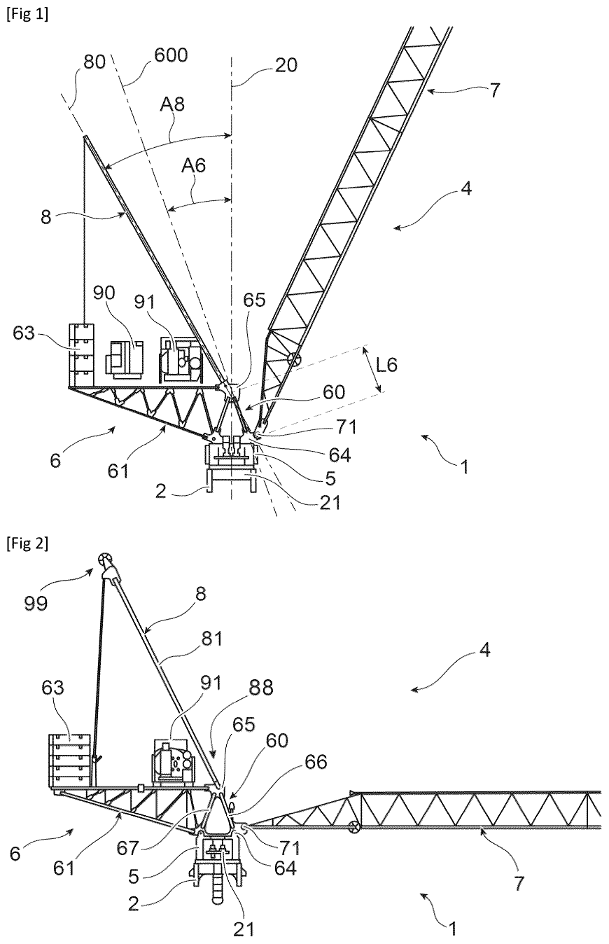

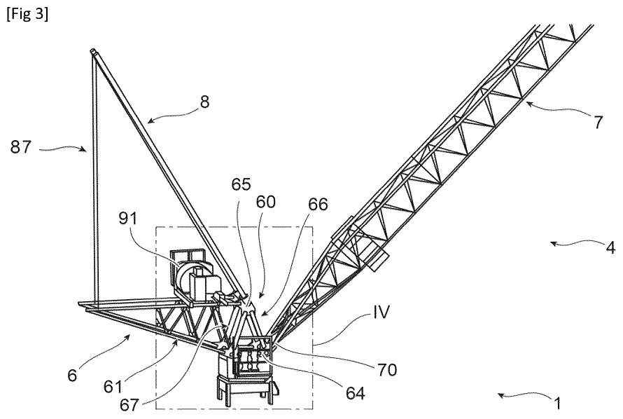

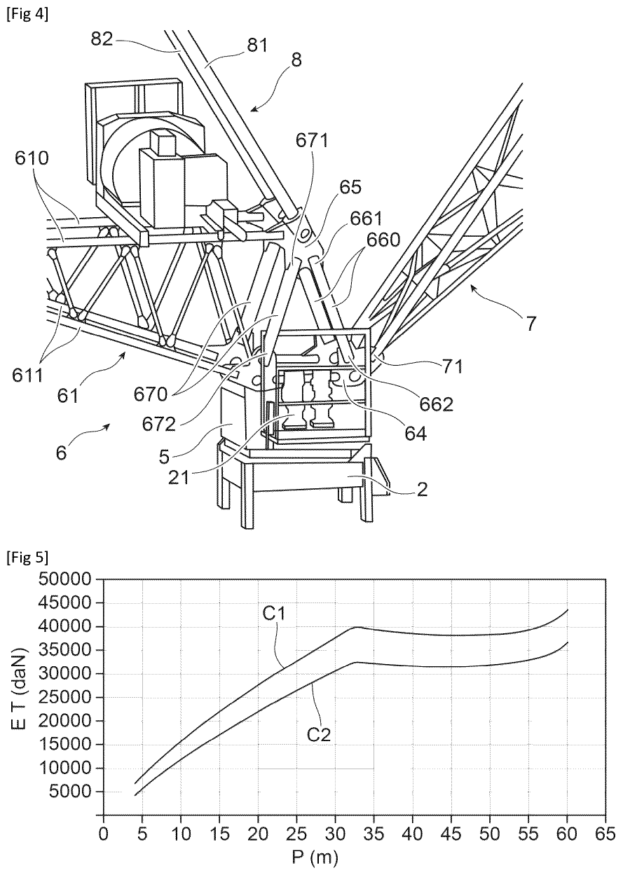

With reference to FIGS. 1 to 4, a luffing jib crane 1 (hereinafter referred to as crane 1) comprises a base frame, stationary or movable on the ground, above which rises a mast 2 which extends along a vertical axis 20. At the top of the mast 2 is mounted, through an orientation device 21, a rotating part 4 orientable about the vertical axis 20 and mainly comprising a rotating pivot 5, a counter-jib 6, a luffing jib 7 and a punch 8.

The rotating pivot 5 is orientable about the vertical axis 20 of the mast 2, and it is pivotally mounted on the mast 2 through the orientation device 21. The rotating pivot 5 can support a driver's cabin of the crane 1.

The counter-jib 6 is fixedly mounted on the rotating pivot 5 in order to be secured in rotation with the latter. The counter-jib 6 comprises a central section 60 and a substantially horizontal radial section 61 directed rearwards and fastened to the central section 60.

The radial section 61 has a platform for carrying equipment which comprises, in particular, a jib lifting winch 90 of the luffing jib 7 and a load lifting winch 91 for lifting loads. The radial section 61 also carries counterweights 63. This radial section 61 can be suspended from the punch 8, in its rear part, by means of one or several connecting tie rods 87.

The jib lifting winch 90 has a drum, around which a jib lifting cable is wound which passes over at least one pulley 99 disposed on the punch 8, and in particular at the top of the punch 8, and which also passes over the pulleys of a jib lifting block (not illustrated), located in front of the punch 8. The jib lifting block is connected, by a line of tie rods (not illustrated), to the luffing jib 7.

The load lifting winch 91 has a drum on which a load lifting cable is wound, which is directed towards a pulley located at the tip of the luffing jib 7 and extends to a load lifting hook (not illustrated), with or without a reeving system, the loads to be lifted being suspended from the hook when using the crane 1.

The central section 60 comprises a base 64 fixedly mounted on the rotating pivot 5 and a top 65 surmounting the base 64 and located above the base 64 along the vertical axis 20.

More specifically, the central section 60 comprises a front structure 66 which is formed of two front arms 660, and a rear structure 67 which is formed of two rear arms 670, where the two front arms 660 join the respective two rear arms 670 at the top 65 of the central section 60 in order to have a general triangle shape for the central section 60.

The front arms 660 comprise a right front arm and a left front arm that extend parallel and obliquely upwards and rearwards. The rear arms 670 comprise a right rear arm and a left rear arm that extend parallel and obliquely upwards and forwards.

Each of these two front arms 660 comprises an upper termination 661 at the top 65 of the central section 60 and a lower termination 662 at the base 64 of the central section 60. The upper terminations 661 of these two front arms 660 form an upper end of the front structure 66, while the lower terminations 662 of these two front arms 660 form a lower end of the front structure 66.

Each of these two rear arms 670 comprises an upper termination 671 at the top 65 of the central section 60 and a lower termination 672 at the base 64 of the central section 60. The upper terminations 671 of these two rear arms 670 form an upper end of the rear structure 67, while the lower terminations 672 of these two rear arms 670 form a lower end of the rear structure 67.

The upper terminations 661 of the two front arms 660 and the upper terminations 671 of the two rear arms 670 are respectively secured to form together the top 65 of the central section 60. Also, the upper end of the front structure 66 and the upper end of the rear structure 67 are joined and secured to the top 65 of the central section 60.

The punch 8 has a foot 88 which is fastened to the top 65 of the central section 60, and extends obliquely upwards and rearwards from the top 65, that is to say with a rearwards inclination. The foot 88 forms the lowest part of the punch 8.

This punch 8 is therefore fastened to the upper ends of the front structure 66 and of the rear structure 67. More precisely, the punch 8 comprises a right oblique element 81 and a left oblique element 82 extending parallel and obliquely upwards and backwards, and the right oblique element 81 is fastened to the upper terminations 661, 671 of the right front arm 660 and of the right rear arm 670, and the left oblique element 82 is fastened to the upper terminations 661, 671 of the left front arm 660 and of the left rear arm 670.

The punch 8, and more precisely its two oblique elements 81, 82, extend in a punch direction 80 which is inclined rearwards relative to the vertical axis 20 at a punch angle A8 comprised between 10 and 50 degrees, and the front arms 660 of the front structure 66 extend in a front direction 600 which is inclined rearwards relative to the vertical axis 20 at a front angle A6 comprised between 5 and 40 degrees. Advantageously, the difference between the punch angle A8 and the front angle A6 is comprised between 0 and 20 degrees, in other words |A8−A6|≤20 degrees. Thus, the punch 8 and the front arms 660 are substantially aligned. The lower terminations 662 of the two front arms 660 and the lower terminations 672 of the two rear arms 670 are connected by bars to form together the base 64 of the central section 60.

The luffing jib 7 is directed forwards and has a rear end 71 articulated, about a horizontal axis, to the central section 60 of the counter-jib 6, in a manner diametrically opposed to the radial section 61 of the counter-jib 6. The rear end 71 of the luffing jib 7 is articulated to the base 64 of the central section 60, below the top 65 along the vertical axis 20, and therefore below the foot 88 of the punch 8. More precisely, the rear end 71 of the luffing jib 7 is articulated to the lower end of the front structure 66, and in particular to the lower terminations 662 of the two front arms 660.

Thus, the rear end 71 of the luffing jib 7 is offset downwards compared to the top 65 of the central section 60, to which the punch 8 is fastened; in other words, the rear end 71 of the luffing jib 7 is offset downwards compared to the foot 88 of the punch 8. In this way, the two front arms 660 form extensions of the respective oblique elements 81, 82 of the punch 8, thus making it possible to fictitiously increase the length of the punch 8 by the length L6 of the front arms 660 or of the front structure 66.

The luffing jib 7 comprises a lattice structure, for example of triangular section. The radial section 61 also comprises a lattice structure, for example of triangular section.

This radial section 61 comprises upper beams 610 which are fastened to the upper ends of the front structure 66 and of the rear structure 67. More precisely, these upper beams 610 comprise a right upper beam and a left upper beam which extend parallel and substantially horizontally rearwards, and the right upper beam is fastened to the upper terminations 661, 671 of the right front arm 660 and of the right rear arm 670, and the left upper beam is fastened to the upper terminations 661, 671 of the left front arm 660 and of the left rear arm 670.

This radial section 61 comprises lower beams 611 which are fastened to the lower ends of the rear structure 67. More precisely, these lower beams 611 comprise a right lower beam and a left lower beam which extend parallel rearwards, and the right lower beam is fastened to the lower termination 672 of the right rear arm 670, and the left lower beam is fastened to the lower termination 672 of the left rear arm 670.

FIG. 5 illustrates a first curve C1 of variation of a force on the line of tie rods ET as a function of the span P on the luffing jib in a conventional luffing jib crane, that is to say in which the rear end of the luffing jib is articulated to the top 65 of the central section 60 of the counter-jib 6, and a second curve C2 of variation of a force on the line of tie rods ET as a function of the span P on the luffing jib in a luffing jib crane 1 as described above, that is to say in which the rear end 71 of the luffing jib 7 is articulated to the base 64 of the central section 60 of the counter-jib 6.

Thus, it is worth noting a reduction in the range of 15% of the force on the line of tie rods ET thanks to the positioning of the articulation of the rear end 71 of the luffing jib 7 on the base 64, which makes it possible to refine and therefore optimize the structures of the counter-jib 6 and of the punch 8.

1. A luffing jib crane comprising a mast surmounted by a rotating part orientable about a vertical axis and comprising:
a rotating pivot pivotally mounted on the mast;
a counter-jib comprising a central section and a substantially horizontal radial section directed rearwards and fastened to the central section, which central section comprising a base fixedly mounted on the rotating pivot and a top surmounting the base and located above the base along the vertical axis;
a luffing jib directed forwards and having a rear end articulated, about a horizontal axis, to the central section of the counter-jib, in a manner diametrically opposed to the radial section of the counter-jib;
a punch having a foot fastened to the top of the central section of the counter-jib, which punch supporting at least one pulley and extending obliquely upwards and backwards from the top of the central section of the counter-jib, and where the radial section of the counter-jib is suspended from the punch by means of at least one connecting tie rod;
said luffing jib crane being characterized in that the rear end of the luffing jib is articulated to the base of the central section of the counter-jib, below the top along the vertical axis, and therefore below the foot of the punch.

2. The luffing jib crane according to claim 1, wherein the central section of the counter-jib comprises:
a front structure extending obliquely upwards and backwards and comprising an upper end at the top of the central section and a lower end at the base of the central section; and
a rear structure extending obliquely upwards and forwards and comprising an upper end at the top of the central section and a lower end at the base of the central section;
wherein the upper end of the front structure and the upper end of the rear structure are joined and secured to the top of the central section;
and wherein the punch is fastened to the upper ends of the front structure and of the rear structure and the rear end of the jib lifting jib is articulated to the lower end of the front structure.

3. The luffing jib crane according to claim 2, wherein the punch extends in a punch direction which is inclined rearwards relative to the vertical axis at a punch angle comprised between 10 and 50 degrees, and the front structure of the central section of the counter-jib extends in a front direction which is inclined rearwards relative to the vertical axis at a front angle comprised between 5 and 40 degrees.

4. The luffing jib crane according to claim 3, wherein the difference between the punch angle and the front angle is comprised between 0 and 20 degrees.

5. The luffing jib crane according to claim 2, wherein the radial section of the counter-jib is fastened to the rear structure of the central section of the counter-jib.

6. The luffing jib crane according to claim 5, wherein the radial section of the counter-jib is fastened to the upper end and the lower end of the rear structure of the central section of the counter-jib.

7. The luffing jib crane according to claim 2, wherein the front structure of the central section of the counter-jib comprises a right front arm and a left front arm extending parallel and obliquely upwards and backwards, the right front arm and the left front arm having respective lower terminations forming the lower end of the front structure, and respective upper terminations forming the upper end of the front structure;
and wherein the rear end of the luffing jib is articulated to the lower terminations of the right front arm and of the left front arm.

8. The luffing jib crane according to claim 7, wherein the rear structure of the central section of the counter-jib comprises a right rear arm and a left rear arm extending parallel and obliquely upwards and forwards, the right rear arm and the left rear arm having respective lower terminations forming the lower end of the rear structure, and respective upper terminations forming the upper end of the rear structure;
wherein the upper termination of the right front arm is joined to the upper termination of the right rear arm, and the upper termination of the left front arm is joined to the upper termination of the left rear arm;
and wherein the punch is fastened to the upper ends of the right front arm, the right rear arm, the left front arm and the left rear arm.

9. The luffing jib crane according to claim 8, wherein the punch comprises a right oblique element and a left oblique element extending parallel and obliquely upwards and backwards, and wherein the right oblique element is fastened to the upper terminations of the right front arm and of the right rear arm, and the left oblique element is fastened to the upper terminations of the left front arm and of the left rear arm.
